(19) United States
(12) Patent Application Publication
(10) Pub. No.: US 2007/0158925 A1
(43) Pub. Date: Jul. 12, 2007

(54) Static pierce point centering spring seat

(76) Inventors: Joseph A. Fader, Brighton, MI (US); Mark Christopher Smith, Troy, MI (US); Paul Kurt Miska, Farmington Hills, MI (US); Muhammad Salim, Windsor (CA); Stephen Heagle, Rockwood (CA); Darryl Sendrea, Brampton (CA); Nathan Clark, Macomb, MI (US); Evan Roger Moen, Clarkston, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/327,107

(22) Filed: Jan. 6, 2006

(51) Int. Cl. B60G 15/00; F16F 1/12; B60G 11/14

(52) U.S. Cl. 280/124.147; 267/175; 267/255; 267/218

(57) ABSTRACT

A shock absorber assembly includes a coil spring that reacts between first and second spring seats. The first spring seat is fixed to a shock cylinder and the second spring support is fixed to a rod that is slidably received within the shock cylinder. At least one of the first and second spring seats comprises an adjustable two-pierce spring seat. First and second spring seat pieces are initially movable relative to each other to achieve a desired spring pierce point location for a selected operational position. Once the first and second spring seat pieces are adjusted to a desired position, the first and second spring seat pieces are permanently attached to each other.

### TECHNICAL FIELD

A shock absorber assembly includes an adjustable two-piece spring seat that is used to set a spring pierce point at a desired location prior to installation in a vehicle.

### BACKGROUND OF THE INVENTION

Shock absorber assemblies react between a vehicle frame and vehicle wheel to reduce vibration and shock load inputs to improve ride comfort. A typical shock absorber assembly includes a cylinder that slidably receives a piston coupled to a rod. One end of the rod is mounted to the vehicle frame and the cylinder is mounted to a vehicle wheel structure. A coil spring reacts between a first spring seat on the cylinder and a second spring seat on the rod.

Side loads generated by the coil spring can cause wear and increased levels of friction between the rod and associated cylinder bearings and seals. This can lead to premature failure of the shock absorber assembly.

It is preferred to maintain a center of load, i.e. spring pierce point, to be generally concentric with the rod. However, the coil ends are typically provided with non-parallel coil end planes, which results in dynamically varying spring pierce points. The interface between the coil ends and associated spring supports can often result in non-uniform distribution of load into the spring supports. This can cause the spring pierce point to move out of a desired location, increasing stress on other shock components.

Dynamic adjustment systems have been used in an attempt to actively maintain the spring pierce point near a center of the rod during vehicle operation. These systems are often expensive and require additional components, which further increases cost. An example of one such system is found in co-pending application no. ______, which is assigned to the assignee of the present invention, and titled “Dynamic Pierce Point Centering spring Seat” and filed on even date herewith. While this system is an improvement over known dynamic systems, there is still a need for a simplified system that does not require dynamic adjustment.

Thus, there is a need for a shock absorber assembly with a simplified adjustment feature that can be used to set a spring pierce point at a desired location to reduce component wear. SUMMARY OF THE INVENTION

A shock absorber assembly includes a two-piece spring seat that allows pre-vehicle installation adjustment to achieve a desired spring pierce point location for a selected operational position. By adjusting the two-piece spring seat prior to installation, the effects of spring side load forces are significantly reduced during vehicle operation.

When the two-piece spring seat is properly positioned, the spring pierce point is maintained generally concentric with a shock absorber piston rod. The spring pierce point comprises a center of load at the spring seat, and maintaining the spring pierce point to be generally concentric with the shock absorber piston rod reduces the effects of side loads.

The subject invention provides a spring seat having a first seat portion and a second seat portion that are movable between a plurality of adjustment positions. Each adjustment position has a unique spring pierce point location. A desired spring pierce point location is selected that corresponds to one of a plurality of operational positions for the shock absorber assembly, e.g. rebound, compression, curb, etc. A shock absorber spring is coupled to one of the first and second seat portions and is moved into the selected operational position. The first and second seat portions are then adjusted to move the spring pierce point to be generally concentric with the shock absorber piston rod. The first and second seat portions are then permanently attached to each other.

In one example the first and second spring seat portions are hemispherical members with mating curved surfaces that are in sliding contact during adjustment. In another example, the first and second spring seat portions are cam surfaces are in sliding contact during adjustment. In either embodiment, once the first and second spring seat portions are in the desired adjustment position, the first and second spring seat portions are fixed to each other by welding, adhesives, fasteners, etc.

The subject invention provides a shock absorber assembly that utilizes a two-piece spring seat configuration to achieve a desired spring pierce point location for a selected shock absorber operational position. This reduces stress on other components of the shock absorber assembly over the operational life of the shock absorber assembly.

These and other features of the present invention can be best understood from the following specification and drawings, the following of which is a brief description.

### BRIEF DESCRIPTION OF THE DRAWINGS

FIG. 1 is a schematic front view of a shock absorber assembly incorporating the subject invention.

FIG. 2A is a schematic view of one example of a spring seat from FIG. 1 incorporating the subject invention.

FIG. 2B is a schematic view indicating a desired spring pierce point location.

FIG. 3 is a schematic view, partially broken away, of the spring seat of FIG. 2 with a different attachment configuration.

FIG. 4 is a schematic view, partially broken away, of the spring seat of FIG. 2A with a different attachment configuration.

FIG. 5 is a perspective view of another example of a spring seat incorporating the subject invention.

FIG. 6 is a cross-section view of the spring seat of FIG. 5.

### DETAILED DESCRIPTION OF THE PREFERRED EMBODIMENT

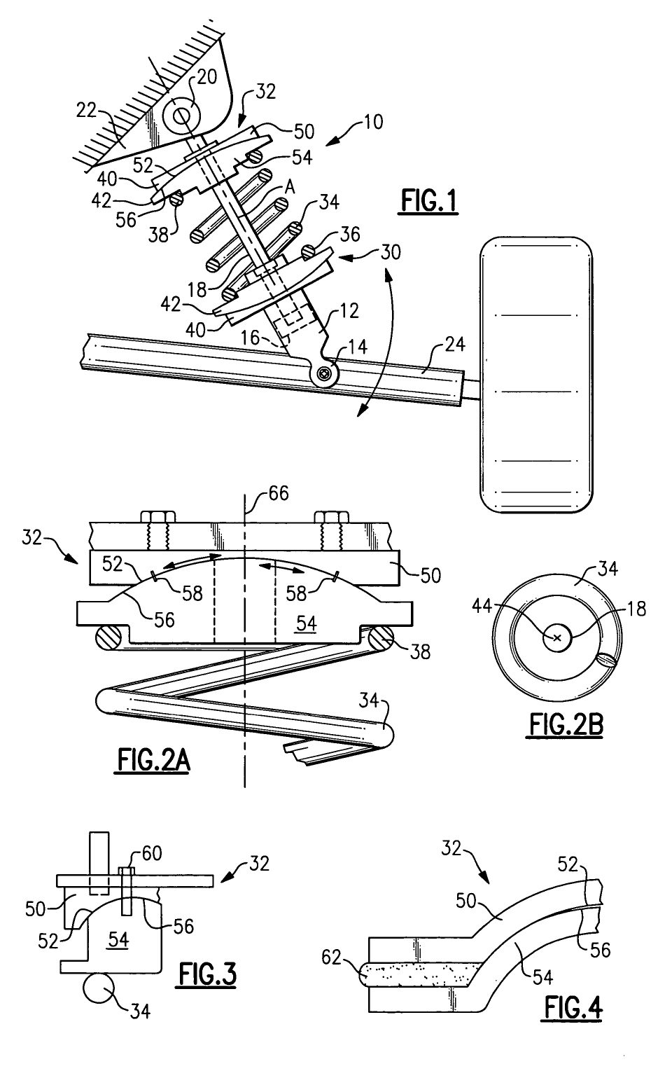

FIG. 1 shows a shock absorber 10 including a cylinder 12 with a first mount 14, a piston 16 received within the cylinder 12, and a rod 18 coupled to the piston 16. The rod 18 defines an axis A that extends along a length of the rod 18. The rod 18 moves the piston 16 back and forth within the cylinder 12 along the axis to compensate for road load inputs as known.

A second mount 20 is attached to the rod 18. The second mount 20 is attached to a vehicle structure 22, such as a frame or chassis member for example. The first mount 14 is attached to a wheel structure 24, such as control arm for example. A reverse orientation could also be used with the first mount 14 being attached to the vehicle structure 22 and the second mount 20 being attached to the wheel structure 24. Further, the first 14 and second 20 mounts can be pivoting mounts as shown in FIG. 1, or could be a fixed mount such as that shown in FIG. 2A.

A first spring seat 30 is fixed to the cylinder 12. A second spring seat 32 is fixed to the rod 18. The first spring seat 30 is preferably mounted directly to an exterior surface of the cylinder 12. The second spring seat 32 is preferably fixed to a portion of the rod 18 that extends outwardly of the cylinder 12, and which is positioned near the second mount 20.

A spring 34 reacts between the first 30 and second 32 spring seats. The spring 34 has a first coil end 36 that is associated with the first spring seat 30 and a second coil end 38 that is associated with the second spring seat 32.

At least one of the first 30 and second 32 spring seats comprises an adjustable spring seat that is formed in two (2) pieces. Optionally, both the first 30 and second 32 spring seats could be adjustable spring seats formed in two pieces. In the examples described below, the second spring seat 32 is described as being formed in two pieces. It should be understood that the first spring seat 30 could be similarly formed if needed.

The second spring seat 32 includes a first seat portion 40 and a second seat portion 42 that are initially movable relative to each other. The first 40 and second 42 seat portions are adjustable between a plurality of different positions to provide the spring 34 of the shock absorber 10 with a desired spring pierce point location 44 (see FIG. 2B) during vehicle operation. Preferably, the spring pierce point location 44. is to be in a generally concentric relationship with the rod 18, i.e. concentric with the axis A. By keeping the spring pierce point location 44 close to the center of the rod 18, the effects of side loading forces are significantly reduced.

The shock absorber 10 is moveable between a plurality of different operational positions, such as a compression position, rebound position, curb position, etc. Each of these positions has a unique spring pierce point location. Depending upon the type of vehicle and the vehicle application, a desired operational position and corresponding spring pierce point location is selected. Preferably, the operational position, which corresponds to a certain spring height, is selected that results in a side force that would potentially be most undesirable for that shock absorber application.

The first spring seat 30 is fixed to the cylinder 12, and the second spring seat 32 is fixed to the rod 18. Once the desired operational position is selected (compression, rebound, curb, etc.), the spring 34 and associated first 40 and second 42 seat portions of the first 30 and second 32 spring seats are moved into the selected operational position by positioning the rod 18 relative to the cylinder 12 in the selected position. The first 40 and second 42 seat portions then move, i.e. adjust, relative to each other such that the spring pierce point location 44 is centered near the center of the rod 18. Once this adjustment position is achieved, the first 40 and second 42 seat portions are permanently attached to each other. This allows the spring pierce point location 44 to be at an “ideal” position for the selected operational position during vehicle operation. The spring pierce point may move out of this “desired” or “ideal” position at other operational positions, however, if properly selected for the vehicle application, the spring pierce point location 44 will be maintained near the ideal location during a significant portion of vehicle operating time.

In the example shown in FIG. 1, the first 40 and second 42 seat portions are comprised of hemispherical shaped body members. A first body member 50 has a first curved surface 52 and a second body member 54 has a second curved surface 56. The second curved surface 56 is in sliding contact with the first curved surface 52 during adjustment. The first body member 50 is fixed to the rod 18. The second body member 54 is rotated relative to the first body member 50 to achieve the selected spring pierce point location 44 (FIG. 2B). The body members 50, 54 are rotated about a horizontal axis that is transverse to a central axis 66 defined by the second spring seat 32 as indicated by arrows shown in FIG. 2A.

Once this adjustment position is achieved the first 50 and second 54 body members are fixed together. In the example, shown in FIG. 2A, the first 50 and second 54 body members are welded to each other as indicated at 58. In the example shown in FIG. 3, the first 50 and second 54 body members are fastened to each other with at least one fastener 60, such as a spike, rivet, bolt, screw, etc. In the example shown in FIG. 4, the first 50 and second 54 body members are fixed together with an adhesive as indicated at 62.

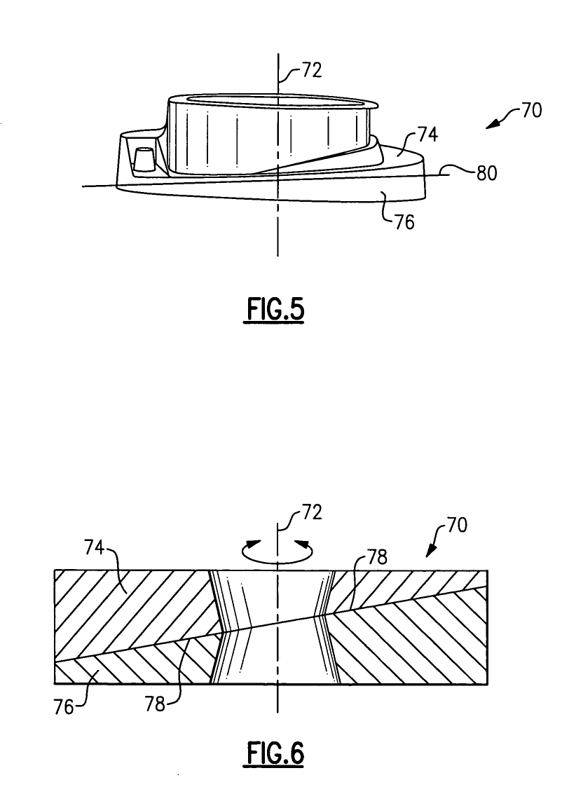

FIGS. 5 and 6 disclose another embodiment of a spring seat 70 formed from two pieces. In this configuration, the spring seat 70 defines a central axis 72 that extends vertically through a center of the spring seat 70. The spring seat 70 includes a first seat portion 74 and a second seat portion 76. During adjustment, the first 74 and second 76 seat portions are rotated relative to each other about the central axis 72. The first 74 and second 76 seat portions each have cam surfaces 78 that are in sliding contact with each other during adjustment. The cam surfaces 78 are generally planar engagement surfaces that are obliquely orientated relative to the central axis 72.

In the example shown, the spring seat 70 is initially formed as a single piece component (see FIG. 5) that is sliced along line 80 in an angular direction to form the cam surfaces 78. In the case of a helical seat as shown, the angle of the “cut” or “slice” can be taken close to an end of the spring and angled 180 degrees away from this point. This allows a minimum amount of package height and material to be utilized. In the case of a spring seat that is piloted on an inner diameter (not shown), engagement surfaces could have the smallest diameter drafting away from this point to eliminate interference during adjustment toward a maximum adjustment limit.

As shown in FIG. 6, opposing first 74 and second 76 seat portions are counter rotated to change an angle between axes of the first 74 and second 76 seat portions. The first 74 and second 76 seat portions are rotated relative to each other to achieve a desired spring pierce point location similar to that described above. Once the first 74 and second 76 seat portions are in the desired orientation, the first 74 and second 76 seat portions are permanently fixed to each other by welding, adhesive, fasteners, etc. If adhesive, epoxy, or other flowing attachment material is used, the first 74 and second 76 seat portions could include criss-crossing grooves (not shown). This allows a bearing surface to be created but does not prohibit the flow of material across the portions.

By reducing the effects of side loads, a smaller shock absorber can be utilized. For example, the size of the rod 18 could be reduced, the wall thickness of the cylinder could be decreased, and/or lower capacity bearings/seals could be realized. Any of these would provide reduced costs and weight of the assembly. Further, lower side loads also reduce friction between the rod and associated bearings/seals, resulting in an improved vehicle ride.

The two-piece spring seat configuration allows an operational position to be selected, which corresponds to a side force that is most undesirable for that shock absorber application. The spring is then positioned at the spring height that corresponds to this selected position. Once this height is reached, the two pieces of the spring seat are fixed to each other to prevent movement through the remainder of the stroke of the spring. This allows piston diameter to be reduced and shock body thickness to be decreased due to the reduction in side force loading at the worst-case assembly height.

The subject invention also provides a system that requires less maintenance than a dynamic, self-adjusting system. Further, less expensive materials can be used for the manufacture of the spring seat pieces because sealing joints and contact wear are not an issue. Also, this unique design improves the overall wear life of the shock absorber, reducing warranty and noise issues.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle shock absorber assembly comprising:
a cylinder having a first mount;
a rod having a first rod end coupled to a piston received within said cylinder and a second rod end having a second mount wherein one of said first and second mounts is adapted for attachment to a vehicle wheel and the other of said first and second mounts is adapted for attachment to a vehicle frame;
a spring reacting between a first spring seat fixed to said cylinder and a second spring seat fixed to said rod, said spring defining at least one spring pierce point; and
wherein at least one of said first and second spring seats comprises a first seat portion and a second seat portion with said first and second seat portions being initially movable relative to each other to be set in one of a plurality of adjustment positions corresponding to different spring pierce point locations and wherein said first and second seat portions are fixed to each other once said first and second seat portions are set in one of said plurality of adjustment positions that corresponds to a desired spring pierce point location.

2. The vehicle shock absorber assembly according to claim 1 wherein said desired spring pierce point location corresponds to a location that is generally concentric with said rod.

3. The vehicle shock absorber assembly according to claim 1 wherein said spring is movable between a plurality of spring positions with each of said plurality of spring positions having a different spring pierce point location, and wherein said plurality of adjustment positions includes at least one adjustment position that corresponds to each of said different spring pierce point locations.

4. The vehicle shock absorber assembly according to claim 3 wherein said plurality of spring positions includes at least a rebound position having a first spring pierce point location, and compression position having a second spring pierce point location, and a curb position having a third spring pierce point location, and wherein when one of said rebound, compression, and curb positions is selected, said first and second seat portions are adjusted relative to each other to set said spring to achieve a corresponding one of said first, second, and third spring pierce point locations, and wherein said first and second seat portions are permanently fixed to each other after adjustment.

5. The vehicle shock absorber assembly according to claim 1 wherein said first seat portion comprises a first body member having a first curved surface and said second seat portion comprises a second body member having a second curved surface that is in sliding contact with said first curved surface during adjustment.

6. The vehicle shock absorber assembly according to claim 1 including a weld feature that permanently attaches said first and second seat portions to each other subsequent to adjustment.

7. The vehicle shock absorber assembly according to claim 1 wherein said first and second seat portions are permanently fixed to each other with adhesive.

8. The vehicle shock absorber assembly according to claim 1 wherein said first and second seat portions are permanently fixed to each other with at least one fastener.

9. The vehicle shock absorber assembly according to claim 1 wherein said first seat portion comprises a first body member having a first cam surface and said second seat portion comprises a second body member having a second cam surface that is in sliding contact with said first cam surface during adjustment.

10. The vehicle shock absorber assembly according to claim 9 wherein said first and second body members define a central axis and wherein said first and second cam surfaces are oblique relative to said central axis.

11. The vehicle shock absorber assembly according to claim 10 wherein said first and second cam surfaces comprise generally planar surfaces.

12. A spring seat for a vehicle shock absorber comprising;
a first seat portion; and
a second seat portion wherein said first and second seat portions are initially movable relative to each other between a plurality of adjustment positions corresponding to different spring pierce point locations, and are subsequently permanently fixed to each other once said first and second seat portions are set at in an adjustment position corresponding to a desired spring pierce point location.

13. The spring seat according to claim 12 wherein said first and second seat portions comprise mating hemispherical surfaces that are in sliding contact during adjustment.

14. The spring seat according to claim 12 wherein said first and second seat portions comprise mating cam surfaces that are in sliding contact during adjustment, said mating cam surfaces being obliquely orientated relative to a central axis defined by said first and second seat portions.

15. A method for adjusting a spring seat to achieve a desired spring pierce point location for a vehicle shock absorber comprising the steps of:
(a) selecting a desired spring pierce point location;
(b) moving at least one of first and second seat portions relative to another of the first and second seat portions to achieve the desired spring pierce point location; and
(c) permanently attaching the first and second seat portions subsequent to step (b).

16. The method according to claim 15 wherein step (b) includes rotating one of the first and second seat portions relative to the other of the first and second seat portions about a central axis defined by the first and second seat portions.

17. The method according to claim 15 wherein the vehicle shock absorber defines a central axis extending along a length of the vehicle shock absorber and wherein step (b) includes rotating one of the first and second seat portions relative to the other of the first and second seat portions about a horizontal axis that is transverse to the central axis.

18. The method according to claim 15 wherein each desired spring pierce point location is generally concentric with a shock absorber piston rod and wherein step (a) includes selecting the desired spring pierce point location from one of a plurality of operational positions including at least a rebound position, compression position, and a curb position; and step (b) includes coupling a spring to one of the first and second seat portions, moving the spring to one of the plurality of operational positions selected during step (a), and adjusting the first and second seat portions to set the desired spring pierce point for the selected operational position.
